(19) United States
(12) Patent Application Publication
(10) Pub. No.: US 2009/0161672 A1
(43) Pub. Date: Jun. 25, 2009

(54) FRAME TRANSFERRING METHOD AND FRAME TRANSFERRING DEVICE

(75) Inventor: Katsumi SHIMADA, Kawasaki (JP)

Correspondence Address: KATTEN MUCHIN ROSENMAN LLP, 575 MADISON AVENUE, NEW YORK, NY, 10022-2585, US

(73) Assignee: FUJITSU LIMITED, Kawasaki-shi (JP)

(21) Appl. No.: 12/333,405

(22) Filed: Dec. 12, 2008

(30) Foreign Application Priority Data
Dec. 19, 2007 (JP) 2007-327227

(51) Int. Cl. H04L 12/56

(52) U.S. Cl. 370/389

(57) ABSTRACT

A frame transferring device includes a storing unit in which whether an output port of the device is to terminate a maintenance frame or transfer the maintenance frame to a different output port of the device is set, the output port being a maintenance point; and a termination deciding unit for deciding whether to terminate the maintenance frame or to transfer the maintenance frame to the different output port of the device and terminate the maintenance frame at the output port at the transfer destination with reference to the storing unit, when a received maintenance frame is destined for the device.

### CROSS-REFERENCE TO RELATED APPLICATIONS

This application is based upon and claims the benefit of priority of the prior Japanese Patent Application No. 2007-327227, filed on Dec. 19, 2007, the entire contents of which are incorporated herein by reference.

### FIELD

The embodiments discussed herein are related to a frame transferring method and a frame transferring device.

### BACKGROUND

A WAN (Wide Area Network) service provided by a plurality of networked frame transferring devices verifies normality of connections by periodically sending and receiving test frames by end-to-end communication in it.

Communication carrier networks for providing Layer 2 VPN (Virtual Private Network) services use a function called CC (Continuity Check) among the Ethernet OAM (“Ethernet” is registered trademark, OAM: Operations, Administration, and Maintenance) functions as a network maintenance function.

For using the CC function, a maintenance point called MEP (Maintenance Entity group end Point; meaning an end point to send and receive CC frames) is set to a frame transferring device that accommodates end users at each position of its ports connected with the end users.

FIG. 1 shows a system configuration diagram of an exemplary network system. In the figure, L2 switches (L2SWs) 1, 2 and 3, which are the frame transferring devices, are connected to the network 4. Each of the L2 switches 1, 2 and 3 has a MEP set thereto.

Each of the L2 switches 1, 2 and 3 sends a CCM (Continuity Check Message) frame to the network periodically, for example at every second. The CCM frame has a destination address (DA) and a source address (SA). The destination address (DA) is a multicast address or a destination's unicast address. In FIG. 1, the first box including “DA” shows a destination address, and the second box including “A”, “B” or “C” shows a source address.

Also, each of the L2 switches periodically receives the CCM frame sent from an MEP (called a Remote MEP and multiple MEPs may be present) that is set to the L2 switch of another end point that belongs to the same VLAN (Virtual Local Area Network), i.e., the same monitored region.

That makes all the MEPs opposite to one another always monitor normality of the network. Generally, if a L2 switch cannot receive the CCM frame from a Remote MEP for three straight cycles, it judges that it is disconnected from the Remote MEP and gives an alarm to a maintenance personnel indicating as such.

In a L2VPN service, multiple end user points are mutually connected (multipoint connection). In the case where end-to-end normality of the network is always monitored in the L2VPN service, each L2 switch monitors normality for each of the Remote MEPs corresponding to the MEPs of itself. For that purpose, the L2 switch sets and stores information on the MEPs set therein and all the Remote MEPs corresponding to the MEPs set therein for each of the MEPs set therein in advance. The number of the Remote MEPs that the L2 switch can set for itself is the number of the sections for which the L2 switch monitors normality of the network.

For example, as shown in FIG. 2, in a network including different communication carrier networks 10 and 11, multiple VLAN (VLAN identifies an end user) frames are transferred through an NNI (Network Node Interface) port that connects the networks 10 and 11 for the purpose of making the network more efficiently accommodate VLANs. In the figure, each black triangle represents an MEP.

As the communication carrier has the NNI port as an end point of the network 10 of itself, the carrier needs to set the MEPs intensively at the NNI port by the same number of the VLANs that the carrier accommodates in the network 10 in order to monitor the network 10 end-to-end.

If the network 10 has the MEPs set by 4094, the maximum number of the VLANs that can be set to a port, and each of the MEPs has multipoint connections with sites at twenty points on average, it is required that 81880 Remote MEPs can be set. With such a great number of the MEPs and the Remote MEPs set, processes for monitoring normality and detecting a failure by receiving the CCM frames from the Remote MEPs concentrates at the position of the NNI port.

Consequently, at the NNI port, a great number of tables are needed for managing a receiving state of the CCM frames, thus, a large memory is needed to be mounted. As the NNI port needs to receive the CCM frame from a Remote MEP per second, a process for reflecting the receiving state of the CCM frames on the tables is not completed within a cycle of a second in the case where a large number of the CCM frames are received. That causes a problem of failing to receive one or more of the CCM frames.

In order to solve the problem, a method using a sophisticated hardware unit that enables the NNI port to receive a large number of the CCM frames and process them at a high speed was developed. The method, however, has a problem of a high cost of the device because of the high-priced hardware unit.

### SUMMARY

According to an aspect of the invention, a frame transferring device includes a storing unit in which whether an output port of the device is to terminate a maintenance frame or transfer the maintenance frame to a different output port of the device is set, wherein the output port is a maintenance point; and a termination deciding unit for deciding whether to terminate the maintenance frame or to transfer the maintenance frame to the different output port of the device and terminate the maintenance frame at the output port at the transfer destination with reference to the storing unit, when a received maintenance frame is destined for the device.

The object and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a system configuration diagram of an exemplary network system;

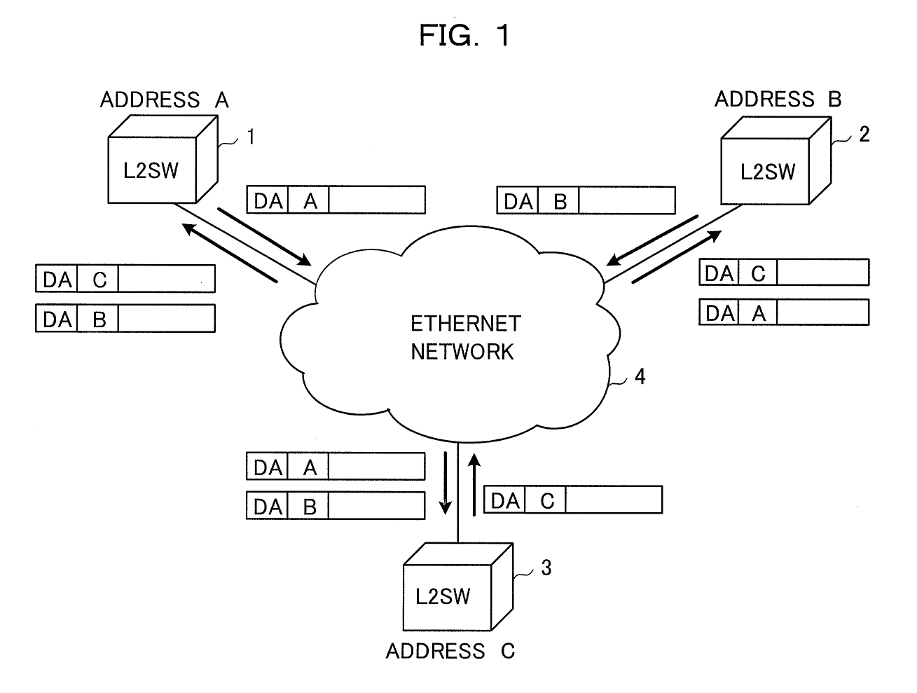

FIG. 2 is a schematic diagram of a network including a plurality of communication carrier networks;

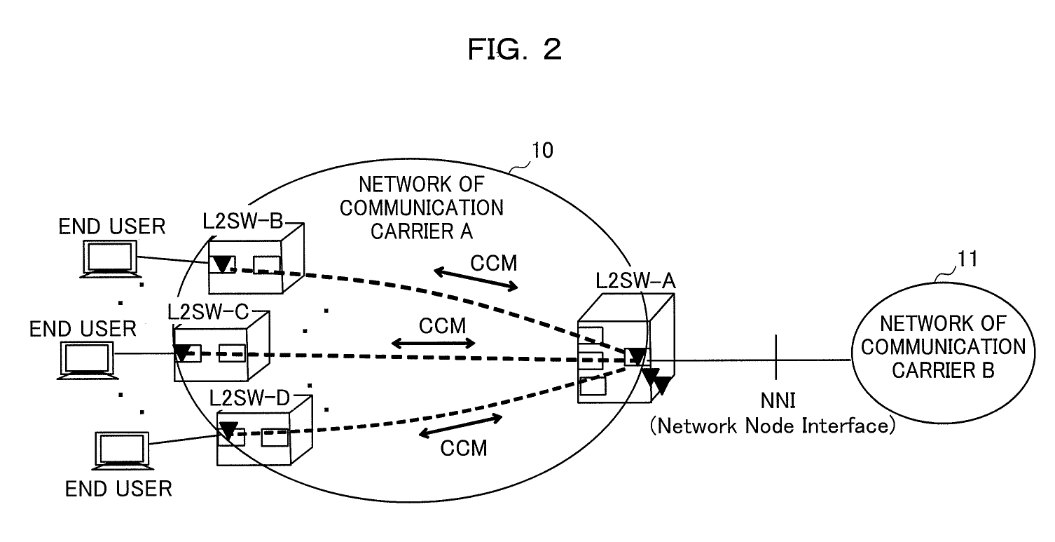

FIG. 3 is a diagram showing an exemplary operation of a frame transferring device according to an embodiment;

FIG. 4 is a perspective view of an appearance of an embodiment of a chassis-type Layer 2 switch;

FIG. 5 is a schematic diagram of a Layer 2 switch having three line units;

FIG. 6 is a block diagram of an embodiment of the Layer 2 switch;

FIG. 7 is a block diagram of a first embodiment of a line unit;

FIG. 8 illustrates a format of a MAC frame;

FIG. 9 illustrates a format of an internal frame header;

FIG. 10 illustrates a format of a CCM frame;

FIG. 11 is a diagram showing a CCM frame receiving state table;

FIG. 12 is a flow chart of processes in a first embodiment;

FIG. 13 is a block diagram of a second embodiment of the line unit; and

FIG. 14 is a flow chart of processes in a second embodiment.

### DESCRIPTION OF EMBODIMENTS

Now, embodiments will be described with reference to the drawings.

A port connected as an NNI port has a great number of the MEPs (self MEPs and Remote MEPs) set therein. On the other hand, as ports other than the NNI port are for relay ports and not for end-to-end monitoring, they have no MEP set. As a result, even if the relay ports have functions of terminating the MEPs, managing the receiving state of the CCM frames and processing the CCM frames, those functions are left unused in the frame transferring device.

By taking advantage of the above-mentioned situation, the embodiment has the other ports (relay ports) in the frame transferring device share the processes of receiving the CCM frames destined for the NNI port and managing the receiving state of the CCM frames among them. The embodiment enables the frame transferring device to deal with even the case where a large number of the CCM frames arrive at one port without raising the cost of the device. Here, the frame transferring device is adapted to manage the receiving state without failing to receive any of the CCM frames.

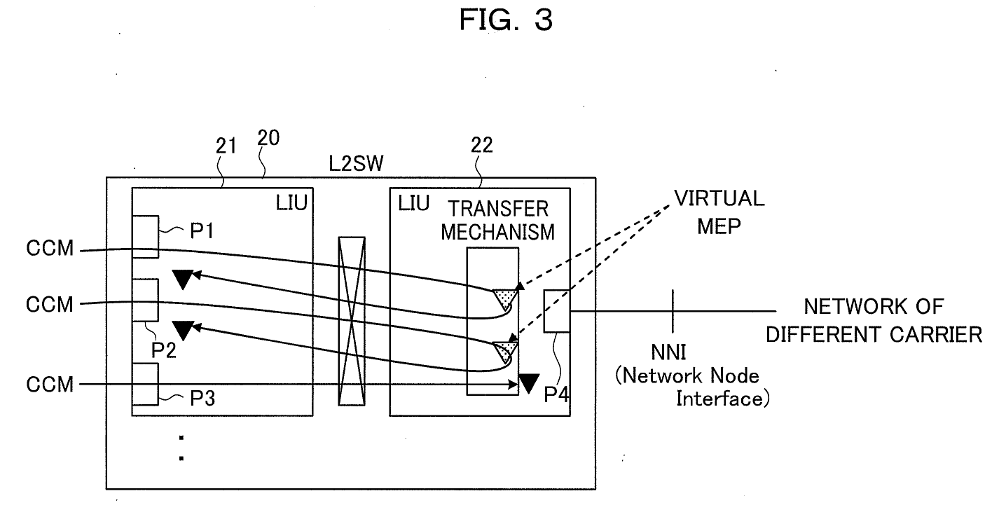

FIG. 3 shows an exemplary operation of the frame transferring device according to the embodiment in which all line units (LIUs) share a process of receiving the CCM frames. In the figure, each black triangle represents an MEP. A frame transferring device 20 has storing means for the MEPs to be set therein at each of ports P1 to P4 of line units (LIUs) 21 and 22 in order to receive the CCM frames that are for monitoring end-to-end connectivity.

The storing means provided at each port has an additional setting of selecting whether to terminate and process a previously arrived CCM frame at the self port or to transfer the CCM frame to another port to be processed therein. Hereinafter, the MEP that is set to transfer the CCM frame to another port is called a virtual MEP, meaning that the MEP has a virtual MEP function. In the figure, a half-tone dotted meshing triangle represents a virtual MEP.

A frame outputting process of the frame transferring device has a mechanism for transferring the CCM frame to another port. For an MEP set as the virtual MEP, the CCM frame is transferred to another port by using the transferring mechanism. For transferring the CCM frame to a port of another line unit, a port number of the transfer destination (the port number may include a line unit number) is previously set in the storing means in which the MEP is set. The port at the transfer destination is set as a general MEP so that the received CCM frame is processed therein.

For transferring the CCM frame to a port of another LIU, the port number of the transfer destination may be decided based on the port number at the port position where the CCM frame was received (for example, based on the number of the port that received the CCM frame, or a result of a predetermined operation performed on the number of the port that received the CCM frame), instead of having the port number of the transfer destination previously set in the storing means in which the MEP is set.

In the frame transferring device 20, the port P4 connected with the NNI is an output port for outputting the CCM frame onto the NNI. The frame transferring device 20 can verify that the received CCM frame can be transferred from an input port to the output port by having the output port perform the processes of receiving the CCM frame and managing the receiving state of the CCM frame.

If the frame transferring device 20 has a monitoring function (not shown) for verifying that the received CCM frame can be transferred from the input port to the output port, the frame transferring device 20 may prevent the CCM frames from concentrating at the output port P4 by setting general MEPs at the positions of the ports P1 and P2 that are for receiving the CCM frames and terminating the CCM frames at the positions of the input ports P1 and P2 instead of setting the above-mentioned virtual MEP transferring mechanism to another port at the position of the output port P4.

Now, the frame transferring device according to the embodiment will be described below by taking an example of a case where the frame transferring device is applied to a Layer 2 switch (L2SW) of a chassis-type structure. The frame transferring device according to the embodiment, however, is not limited to the Layer 2 switch of a chassis-type structure, and may be applied to a Layer 2 switch consisting of a plurality of functional blocks for sending and receiving frames, and on which many ports can be mounted.

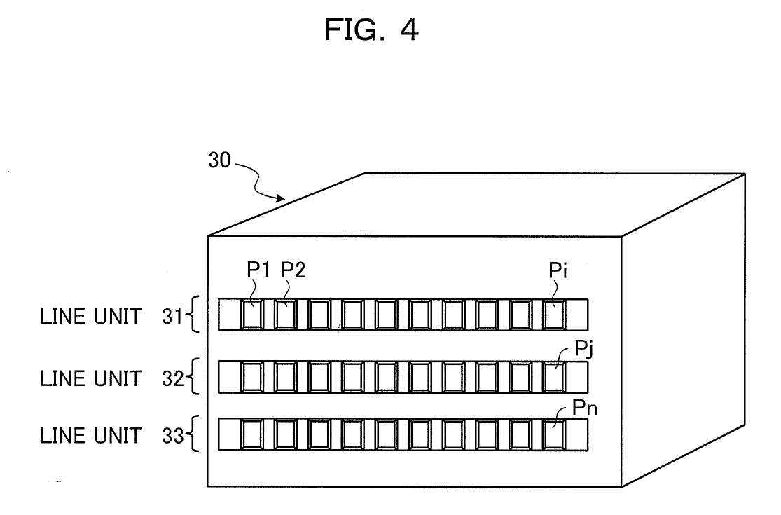

FIG. 4 shows a perspective view of an appearance of an embodiment of a chassis-type Layer 2 switch 30. In the figure, each of line units 31 to 33 has one or more interface ports. To each of the ports P1 to Pn of the line units 31 to 33, an end user's terminal is connected in some occasions, and another Layer 2 switch is connected in other occasions.

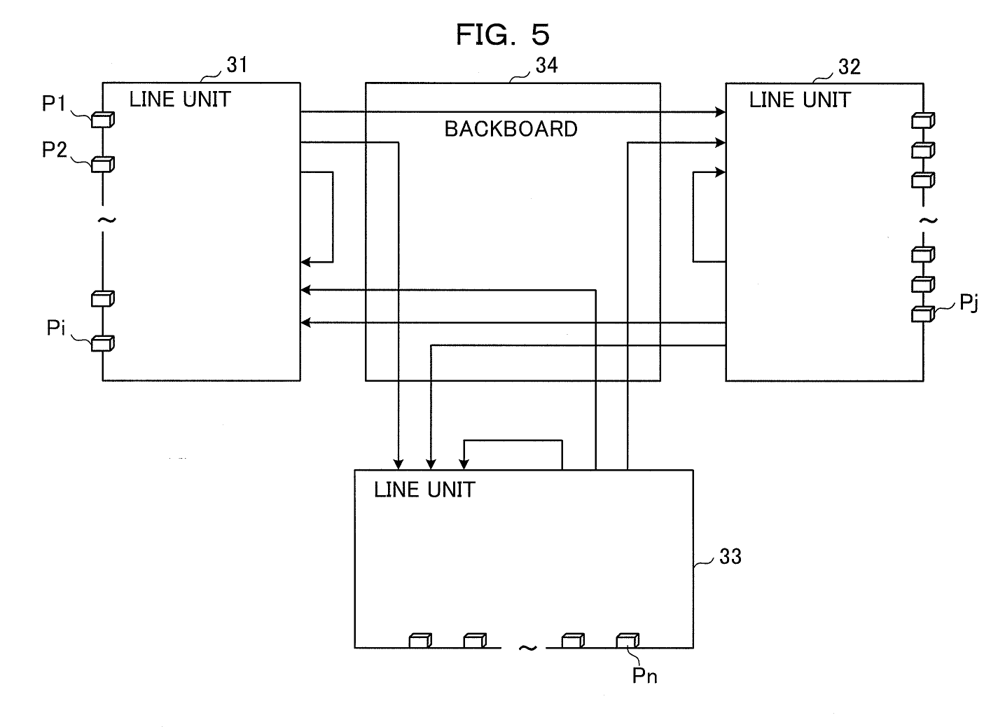

FIG. 5 shows a schematic diagram of an exemplary Layer 2 switch 30 having three line units. In the figure, each of the line units 31 to 33, having three outputs for different destinations and three inputs from different sources against a backboard 34, relays a packet between any of the ports P1 to Pn.

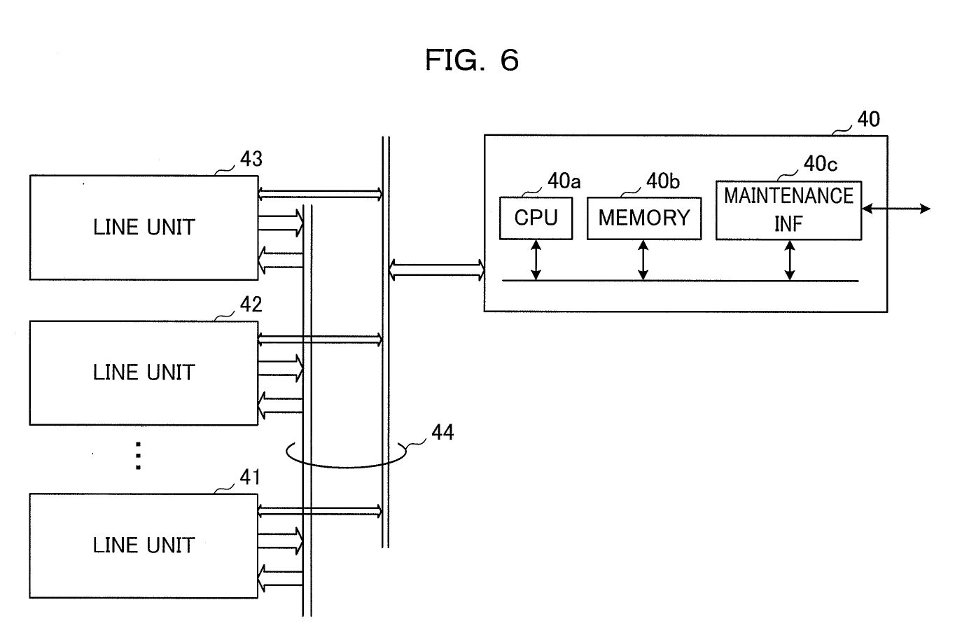

FIG. 6 is a block diagram of an embodiment of a Layer 2 switch. In the figure, the Layer 2 switch includes a setting control unit 40, line units 41, 42, and 43, and the backboard (back wiring board) 44.

The backboard 44 mutually connects the line units 41 to 43 and the setting control unit 40. The setting control unit 40, which has a CPU 40a, memory 40b, and a maintenance interface 40c, implements: setting of maintenance data into the line units 41 to 43; monitoring of state data from the line units 41 to 43; controlling over state transition to the line units 41 to 43; and an interface between the Layer 2 switch and the maintenance personnel for a state setting signal. More line units may be added according to the number of the links that the Layer 2 switch accommodates and the transfer rates of the links.

### First Embodiment of Line Unit

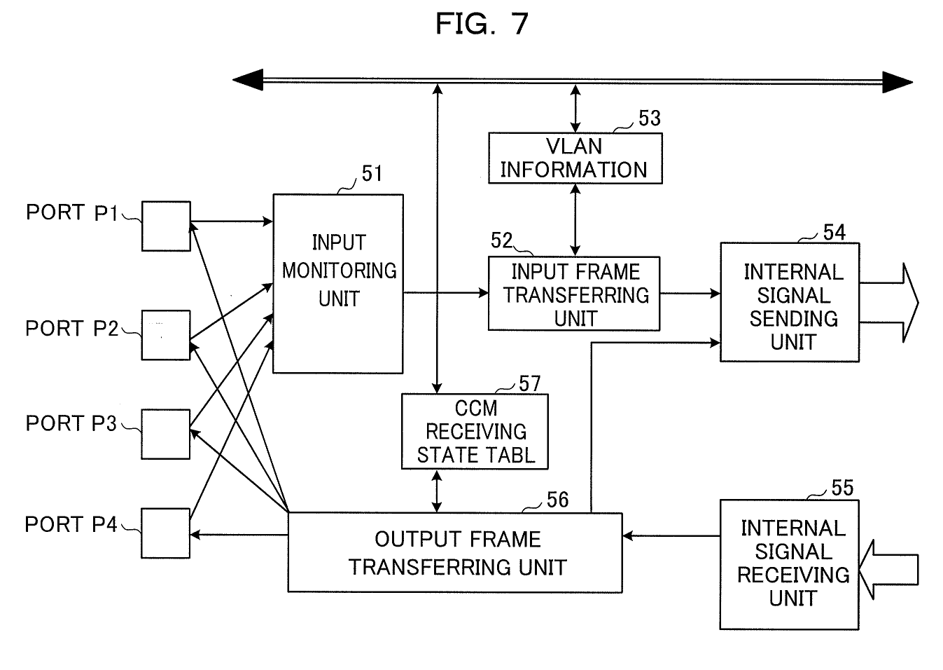

FIG. 7 shows a block diagram of a first embodiment of the line unit. In the figure, the line unit has the four ports P1, P2, P3, and P4, each of which is for inputting and outputting an Ethernet (registered trademark) frame. The frame that is received at each of the ports P1 to P4 is temporarily stored in an input monitoring unit 51.

The input monitoring unit 51 monitors normality of the frame, prepares an internal frame header for exchanging necessary information in the frame transferring device, adds the internal frame header to the frame, and then supplies the frame with the internal frame header to an input frame transferring unit 52.

The input frame transferring unit 52, which receives the frame with the internal frame header added, decides the line unit and the port to which the frame is to be transferred in the frame transferring device with reference to a learning table (not shown) and VLAN information 53 based on the destination MAC (Media Access Control) address and the VLAN-ID in the frame; updates the internal frame header; adds the internal frame header to the received frame; and supplies the frame with the internal frame header to an internal signal sending unit 54. The deciding about the transfer destination of the frame based on the learning table and the VLAN information may be based on technology stipulated by the IEEE 802.1d.

To the backboard 44, the internal signal sending unit 54 delivers the frame with the internal frame header added that is supplied from the input frame transferring unit 52 or an output frame transferring unit 56. An internal signal receiving unit 55 receives a frame with an internal frame header added from the backboard 44, and then transfers only the frame destined for the self line unit to the output frame transferring unit 56 and discards the frame that is not destined for the self line unit.

The output frame transferring unit 56 implements learning on a source MAC address in the frame by searching the learning table (not shown) for the source MAC address. The output frame transferring unit 56 is responsible for transferring and termination of the CCM frame as well as transferring of a frame to a corresponding port according to the internal frame header. The setting control unit 40 controls over and sets the entries of the VLAN information 53 and a CCM frame receiving state table 57.

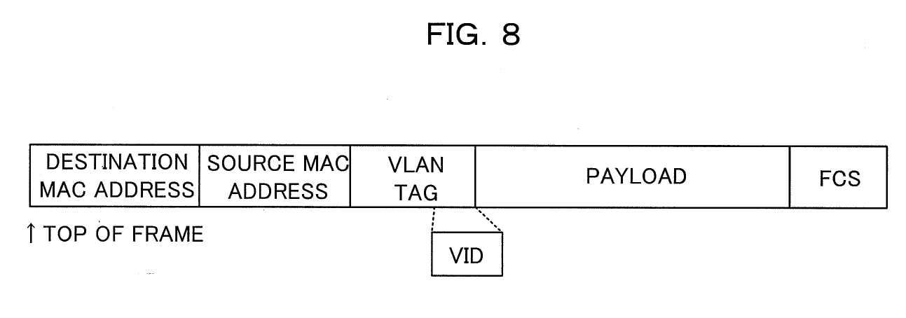

FIG. 8 shows a format of a MAC frame. The MAC frame includes a destination MAC address, a source MAC address, a VLAN tag, a payload, and an FCS (frame check sequence). The VLAN tag includes a VID (12 bits) for identifying an end user.

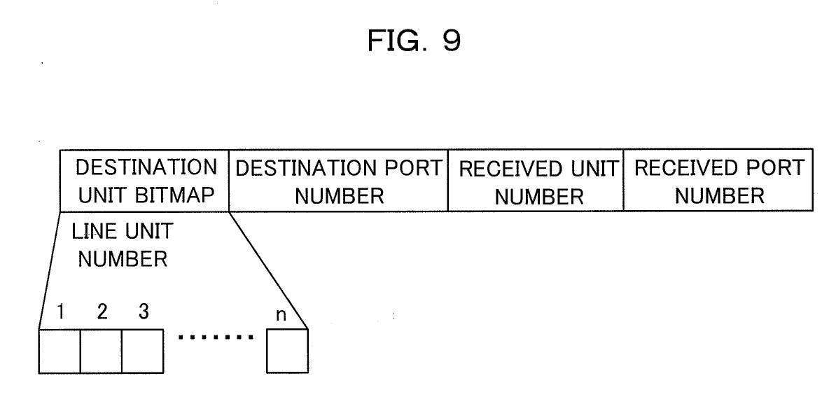

FIG. 9 shows a format of an internal frame header. The internal frame header, which includes a destination unit bitmap, a destination port number, a received unit number, and a received port number, is added to the top of the MAC frame. The destination unit bitmap has bitmaps corresponding to the line unit numbers of the line units 41 to 43, which are provided for the Layer 2 switch. Each of the bitmaps sets 1 or 0 (for example, 1 represents the corresponding line unit) in the bit of the corresponding line unit. The internal frame header is transferred to the input frame transferring unit 52 with the received frame.

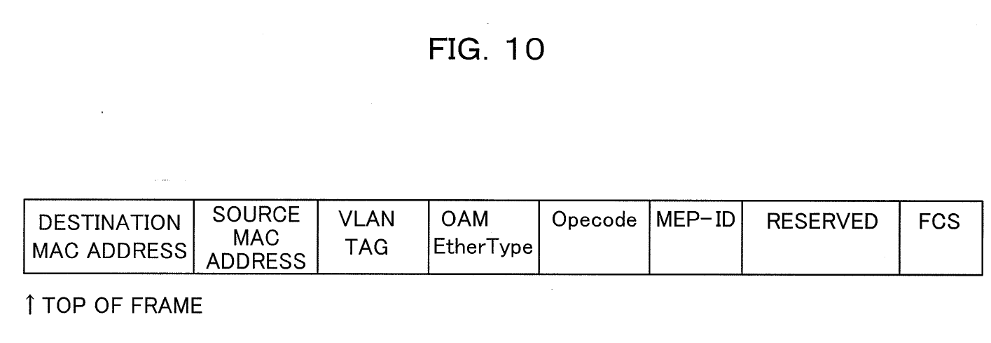

FIG. 10 shows a format of a CCM frame for the Ethernet OAM. The CCM frame is a kind of MAC frame. When OAM_EtherType (2 bytes) has a specific value, the frame is recognized as an Ethernet OAM frame, and when Opecode (1 byte) has a specific value, the frame is recognized as a CCM frame.

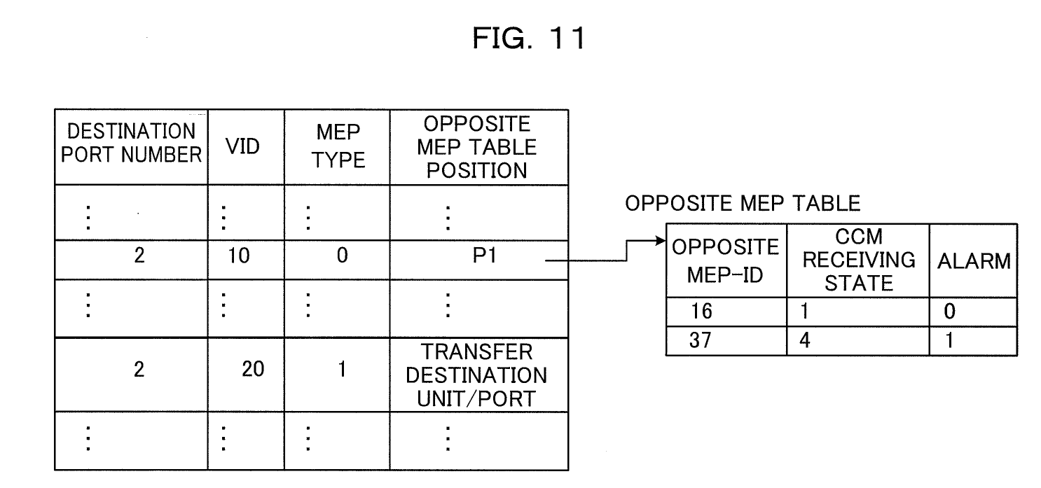

FIG. 11 shows a diagram of the CCM frame receiving state table 57. When the maintenance personnel gives an instruction to set the MEPs with specifications of the ports and the VIDs by using the maintenance interface 40c of the setting control unit 40 shown in FIG. 6, the setting control unit 40 prepares a line (entry) having the specified destination port number and VID on the CCM frame receiving state table 57 for each of the MEPs (MEP-IDs).

The maintenance interface 40c is also used for specifying the MEP type. When a general MEP is specified, 0 is set in the entry of the MEP type. For the general MEP, the Remote MEP corresponding to the MEP is specified in the entry of a Remote MEP table position. For the virtual MEP, 1 is set in the entry of the MEP type and the transfer destination unit/port for specifying the unit and the port at the transferred destination is set in the entry of the Remote MEP table position.

As a plurality of Remote MEPs are registered for a MEP, the Remote MEP table for registering the Remote MEPs is included in the CCM frame receiving state table 57 such that the Remote MEP table is prepared at a different storage location and a pointer to the Remote MEP table is set at the Remote MEP table position in the CCM frame receiving state table 57. The table structure of the CCM frame receiving state table 57 including the Remote MEP table shown here is merely an example, and the CCM frame receiving state table 57 may have another table structure with the same function.

Each Remote MEP table includes the entries of a Remote MEP-ID, a CCM frame receiving state, and an alert state. The Remote MEP-ID is registered in the table based on the value specified by the maintenance interface 40c.

When a virtual MEP is specified by the maintenance interface 40c, 1 is set in the entry of the MEP type of the CCM frame receiving state table 57. For the virtual MEP, no Remote MEP table is prepared for the unit. Instead, the unit and the port for actually terminating the CCM frame are specified by the maintenance interface 40c. The specified value is set at the Remote MEP table position.

In addition, by using the maintenance interface 40c, the line unit and the port for actually terminating the CCM frame destined for the abovementioned virtual MEP are specified, and the CCM frame receiving state table and the Remote MEP table are prepared as in the case of the general MEP. The table structure of each table here is identical to that described above. The entry of the CCM frame receiving state in the Remote MEP table is also used for detecting an alert in the case where no CCM frame is received from the Remote MEP for a certain period.

In the output frame transferring unit 56, the value in the entry of the CCM frame receiving state is incremented for each line of all the Remote MEP-IDs in the Remote MEP table periodically, for example at every second. If the value is incremented to four or more, that means no CCM frame is received for four or more seconds. Then, 1 (meaning “being alerted”) is set in the entry of the “alarm”/alert state. The CCM frame receiving state is initialized when the CCM frame with the matched MEP-ID is received.

If the value in the entry of the CCM frame receiving state is three or less, 0 (meaning “have not been alerted”) is set in the entry of the “alarm”/alert state. The alert state is periodically checked by the setting control unit 40. For the MEP that has 1 in the entry of the alert state, the setting control unit 40 notifies, through the maintenance interface 40c, an external device that an alert is given.

### <Flow Chart of Processes in the First Embodiment>

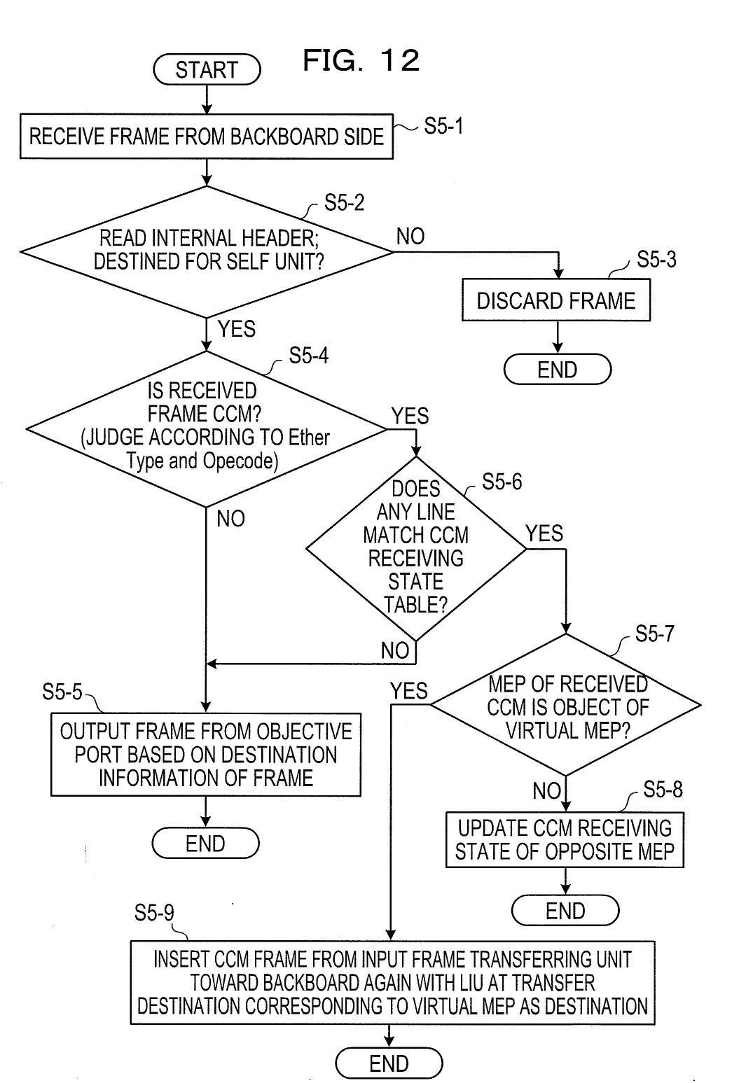

Processes performed in the case where the transfer destination of the CCM frame that was received by an input side line unit is decided and the CCM frame enters the internal signal receiving unit 55 will be described with reference to the flow chart of FIG. 12.

Step S5-1: The internal signal receiving unit 55 receives a frame with the internal frame header added.

Step S5-2: The internal signal receiving unit 55 judges whether the received frame is destined for the self line unit, or not, based on the destination unit bitmap in the internal frame header. The internal signal receiving unit 55 recognizes the self line unit number based on the implementation table (not shown).

Step S5-3: This step follows the case where the received frame is judged not destined for the self line unit at step S5-2. The internal signal receiving unit 55 discards the received frame.

Step S5-4: This step follows the case where the received frame is judged destined for the self line unit at step S5-2. The processes shown below are performed by all of the implemented line units 41 to 43. The output frame transferring unit 56 examines the value at the OAM_EtherType position and the position of Opecode in the frame. If it is not the CCM frame, the operation proceeds to S5-5. If it is the CCM frame, the operation proceeds to S5-6.

Step S5-5: The frame is outputted from an objective port according to information in the internal frame header.

Step S5-6: The output frame transferring unit 56 searches the CCM frame receiving state table 57 for a line in which the destination port number in the internal frame header matches a VID in the VLAN tag. If no such line is found, the frame is treated as a general frame, and the operation proceeds to S5-5. If the line is found, the operation proceeds to S5-7.

Step S5-7: The MEP type is checked. If the MEP type is 0, it is judged a general MEP, and the operation proceeds to S5-8. If the MEP type is 1, the operation proceeds to S5-9.

Step S5-8: The Remote MEP table is searched for a line that matches the MEP-ID in the received CCM frame. If no such line is found, nothing is performed here other than discarding the frame. If the line is found, the CCM frame receiving state is initialized to 0, and then the frame is discarded. That means the CCM frame is terminated at step S5-8.

If a time elapsed between the previous reception of the CCM frame from the corresponding Remote MEP and the next reception of the CCM frame is found to be less than four seconds as a result of initialization of the CCM frame receiving state to 0, the Remote MEP is not in the alert state. Based on that, normality of the communication with the Remote MEP can be verified.

Step S5-9: If the MEP type is found to be the virtual MEP as a result of searching the CCM frame receiving state table 57, the value (pointer) in the entry of the Remote MEP table position that is stored in the CCM frame receiving state table 57 is retrieved. The value is set in the entry of the destination port number of the internal frame header and supplied to the internal signal sending unit 54. In the line unit at the destination of the transferred CCM frame, the general MEP is registered in the CCM frame receiving state table as mentioned above. When the line unit receives the CCM frame, it reflects that on the entry of the CCM frame receiving state at the corresponding line in the Remote MEP table.

The frame transferring device can perform the processes for receiving the CCM frame and detecting the alert by having all the line units 41 to 43 share the processes as mentioned above, even if a large number of CCM frames arrive at a single port of a single line unit. That means there is no need to replace a specific line unit by sophisticated one to deal with such a situation. Therefore, the cost of the frame transferring device can be restrained from increasing. Here, the moderately priced frame transferring device that enables many sections for monitoring end-to-end connectivity of the network to be set can be provided.

The process shown below is also possible as a modification of the first embodiment. At step S5-9, the received unit number and the received port number in the internal frame header is set in the entry of the destination port number in the internal frame header for the purpose of transferring the CCM frame from the virtual MEP to the general MEP, instead of setting the value in the entry of the Remote MEP table position in the entry of the destination port number of the internal frame header.

This is because the port that received the CCM frame (indicated by the received unit number and the received port number in the internal frame header) is a relay port, and thus, the CCM frame receiving state table 57 is not used. In the modification, the general MEP is set and the Remote MEP table is set in the line corresponding to the CCM frame received port in the CCM frame receiving state table 57 as mentioned above.

### Second Embodiment of Line Unit

In the case where the transferring mechanism in the frame transferring device ensures that the received CCM frame can be transferred from the input port to the output port of the device, the general MEPs are set at the port position where the CCM frame is to be received and the CCM frames are terminated at the input port positions so that the CCM frames are prevented from concentrating at the output port, instead of setting the MEPs at the output port positions at the transfer destination of the CCM frame.

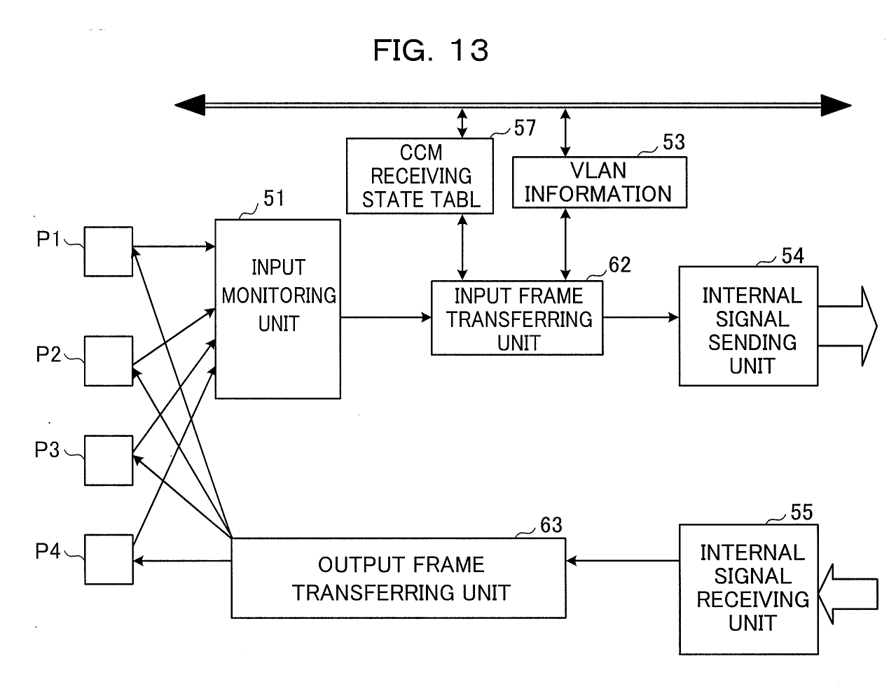

FIG. 13 shows a block diagram of a second embodiment of the line unit in the abovementioned case. The second embodiment differs from the first embodiment in that an input frame transferring unit 62 references the CCM frame receiving state table 57. The CCM frame receiving state table 57 used in this case is identical to that described above.

As the input frame transferring unit 52 does, the input frame transferring unit 62 decides the line unit and the port to which the frame is to be transferred in the frame transferring device with reference to a learning table (not shown) and VLAN information 53 based on the destination MAC address and the VLAN-ID in the frame; updates the internal frame header; adds the internal frame header to the received frame; and supplies the frame with the internal frame header to an internal signal sending unit 54.

In that case, the output frame transferring unit 63 only transfers the frame to the corresponding port according to the internal frame header and does neither transferring nor terminating of the CCM frames.

### <Flow Chart of Processes in the Second Embodiment>

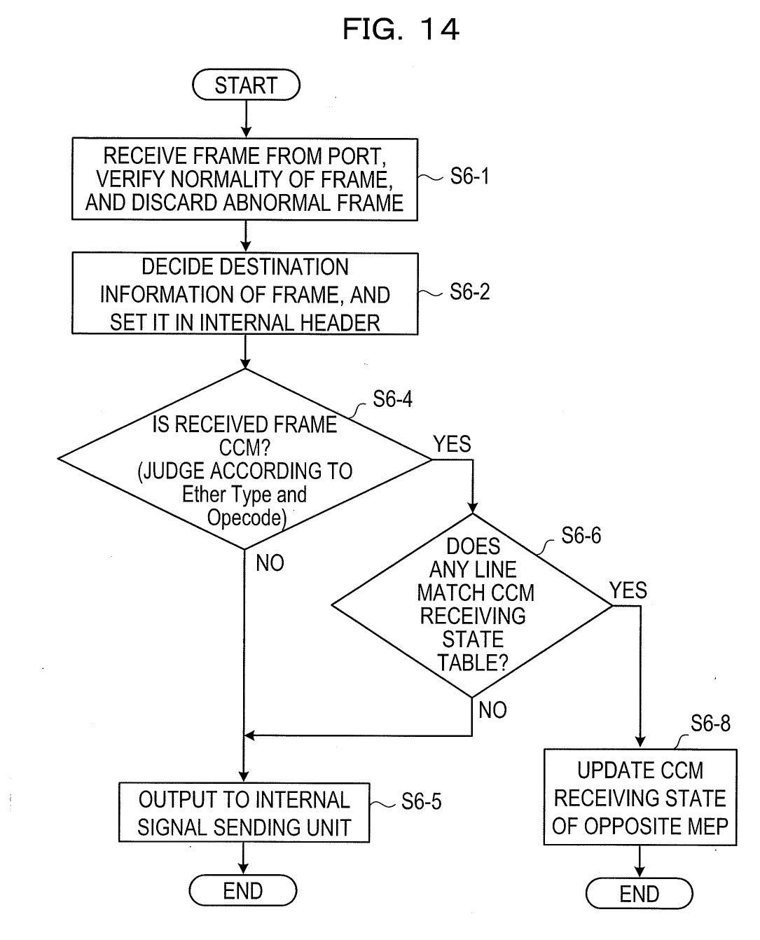

Processes in the case where the CCM frame is received by the input side line unit will be described with reference to the flow chart of FIG. 14.

Step S6-1: The input monitoring unit 51 verifies normality of the received frame. A frame found to be abnormal is discarded. The input monitoring unit 51 keeps the port number and the line unit number of the port and the line unit that received a normal frame in the entries of the received port number and the received line unit number of the internal frame header. At step S6-1, the input monitoring unit 51 adds the internal frame header to the received frame and transfers them to the input frame transferring unit 62.

Step S6-2: The input frame transferring unit 62 decides the transfer destination of the frame according to the learning table (not shown) and the VLAN information 53, and sets the transfer destination in the information of the destination unit bitmap and the destination port number in the internal frame header.

Step S6-4: As at step S5-4, whether the frame is the CCM frame or not is examined. If the frame is the CCM frame, the operation proceeds to S6-6. If the frame is not the CCM frame, the operation proceeds to S6-5.

Step S6-5: The frame with the internal frame header added is supplied to the internal signal sending unit 54.

Step S6-6: The CCM frame receiving state table 57 is searched for a line in which the destination port number in the internal frame header matches a VID in the VLAN tag. If no such line is found, the frame is treated as a general frame, and the operation proceeds to S6-5. If the line is found, the operation proceeds to S6-8.

Step S6-8: As at step S5-8, the Remote MEP table is searched for a line that matches the MEP-ID in the received CCM frame. If no such line is found, nothing is performed here other than discarding the frame. If the line is found, the CCM frame receiving state is initialized to 0, and then the frame is discarded. That means the CCM frame is terminated at step S6-8.

In that manner, the embodiment can prevent the CCM frames from concentrating at one output port by setting the output side MEPs in the input ports instead of setting the MEPs in the output port in the device.

Even in the case where the CCM frames from multiple Remote MEPs intensively arrive at some of the ports in the frame transferring device, the second embodiment can decentralize loads on some of the ports by having the other processing units without any load in the device share the CCM frame terminating process. That means the second embodiment can monitor normality of the connection with multiple Remote MEPs without taking such measures that require a higher cost of the device as increasing memory or mounting a high-speed processor to the device.

The second embodiment uses the CCM frame receiving state table 57 as an example of storing means, the output frame transferring unit 56 as an example of termination deciding means, the output frame transferring unit 56 as an example of transferring means, and the input frame transferring unit 62 as an example of terminating means.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

What is claimed is:

1. A frame transferring device, comprising:
a storing unit in which whether an output port of said device is to terminate a maintenance frame or transfer the maintenance frame to a different output port of said device is set, wherein said output port is a maintenance point; and
a termination deciding unit for deciding whether to terminate said maintenance frame or to transfer said maintenance frame to the different output port of said device and terminate said maintenance frame at the output port at the transfer destination with reference to said storing unit, when a received maintenance frame is destined for said device.

2. The frame transferring device according to claim 1, further comprising:
a transferring unit for transferring said maintenance frame to the different output port of said device when said termination deciding unit decides to transfer said maintenance frame to the different output port of said device.

3. The frame transferring device according to claim 2, wherein
said transferring unit decides the position of the different output port of said device to which said maintenance frame is to be transferred based on a position of an input port that received said maintenance frame.

4. The frame transferring device according to claim 2, wherein
said storing unit has a position of the different output port of said device to which said maintenance frame is to be transferred preset.

5. A frame transferring method, comprising:
a step of storing whether an output port of said device is to terminate a maintenance frame or transfer the maintenance frame to a different output port of said device, wherein said output port is a maintenance point; and
a step of deciding whether to terminate said maintenance frame or to transfer said maintenance frame to the different output port of said device and terminate said maintenance frame at the output port at the transfer destination according to said storing, when a received maintenance frame is destined for said device.
